(19) United States
(12) Patent Application Publication
(10) Pub. No.: US 2014/0324743 A1
(43) Pub. Date: Oct. 30, 2014

(54) AUTOREGRESSIVE MODEL FOR TIME-SERIES DATA

(71) Applicant: HEWLETT-PACKARD DEVELOPMENT COMPANY, L.P., (US)

(72) Inventors: Choudur LAKSHMINARAYAN, Austin, TX (US); D. Shyama PURNIMA, Hyderabad (IN); Vivek BOOMINATHAN, Houston, TX (US)

(73) Assignee: HEWLETT-PACKARD DEVELOPMENT COMPANY, L.P., Houston, TX (US)

(21) Appl. No.: 13/874,186

(22) Filed: Apr. 30, 2013

(51) Int. Cl. G06N 5/04; G06N 99/00

(52) U.S. Cl. CPC G06N 5/04; G06N 99/005
USPC 706/12; 706/58

(57) ABSTRACT

A technique includes fitting an autoregressive integrated moving average (ARIMA) model to time-series data. The technique further includes the computation of autoregression coefficients from the ARIMA model applied to the time-series data. The autoregression coefficients may be usable for data classification purposes.

### BACKGROUND

Many systems are instrumented with various types of sensors. Such sensors provide signals that can be analyzed to detect problems with the operation of the system. For example, oil and gas wells may have flow sensors that indicate the rate of flow in the well at the location of the sensors. Detection of, and response to, an erroneous condition may help avoid a serious problem.

### BRIEF DESCRIPTION OF THE DRAWINGS

For a detailed description of various examples, reference will now be made to the accompanying drawings in which:

FIG. 1 illustrates computation of cepstrum coefficients of time-series data in accordance with the disclosed principles;

FIG. 2 shows a system including an autoregression-based regime determination system in accordance with the disclosed principles

FIG. 3 illustrates the use of the autoregression-based regime determination system in accordance with the disclosed principles;

FIG. 4 illustrates an implementation of the autoregression-based regime determination system in accordance with the disclosed principles;

FIG. 5 illustrates another implementation of the autoregression-based regime determination system in accordance with the disclosed principles;

FIG. 6 illustrates a method for processing training data in accordance with the disclosed principles;

FIG. 7 illustrates averaging cepstrum coefficients across various frames of data in accordance with the disclosed principles;

FIG. 8 illustrates a method for classifying live time-series data based on an autoregression model in accordance with the disclosed principles;

FIG. 9 illustrates another method for classifying live time-series data based on an autoregression model in accordance with the disclosed principles;

FIG. 10 illustrates an implementation of template matching using orthogonal matching pursuit for data classification in accordance with the disclosed principles; and

FIG. 11 illustrates an implementation of discriminative analysis for data classification in accordance with the disclosed principles.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct connection or through an indirect connection via other devices and connections.

### DETAILED DESCRIPTION

Many types of data have an oscillatory pattern that is normal (i.e., indicative of problem-free behavior). Such data is referred to herein as normal oscillation (NO) data. However, during various types of problem conditions, the data may become characteristic of high amplitude oscillation (HAO) or low amplitude oscillation (LAO). Data that is HAO or LAO may be indicative of various problems that can be addressed and resolved if detected in time. HAO and LAO data may have a frequency that is similar, but higher than that of NO data. HAO data may be characterized by amplitude swings that are greater than that of NO and LAO data, while the amplitude swings for LAO data may be less than that of NO and HAO data. Each of the NO, LAO and HAO data are referred to as a “regime.” The disclosed technique classifies data as NO, LAO, or HAO regime data, but the technique is applicable as well to data classification for other than a three-regime application.

An example of a system that has NO type data during normal system operation, but may become HAO or LAO during abnormal system operation is an oil/gas well. The data may be generated by flow rate sensors that are provided along the drill string. Each flow rate sensor generates a signal indicative of the rate of flow of the produced material (oil, gas). During normal well operation, the rate of flow may increase and decrease over time and at a normal level of oscillation. During certain problem conditions, the flow rate may become HAO or LAO in nature. Another example of a system that may have NO, LAO and HAO tendencies is an electrocardiogram (ECG) of a patient.

The disclosed technique involves processing of NO, LAO and HAO training data to generate coefficients that are unique to each such regime. The coefficients then may be used to classify live time-series data. Live time-series data comprises data that is not training data and for which classification is desired into one of the regimes.

In various examples, the classification process described herein is based on autoregressive modeling. Some types of time-series data is autoregressive in nature meaning the value of the data at any point in time is correlated to some degree with the data at some prior point in time. HAO, NO, and LAO flow rate sensor data are autoregressive. An autoregressive integrated moving average (ARIMA) model can be fit to each of HAO, NO, and LAO training data to generate autoregression (AR) coefficients. The AR coefficients for each of the HAO, NO, and LAO regimes may be different and thus can be used to classify live data into one of the three regime classifications.

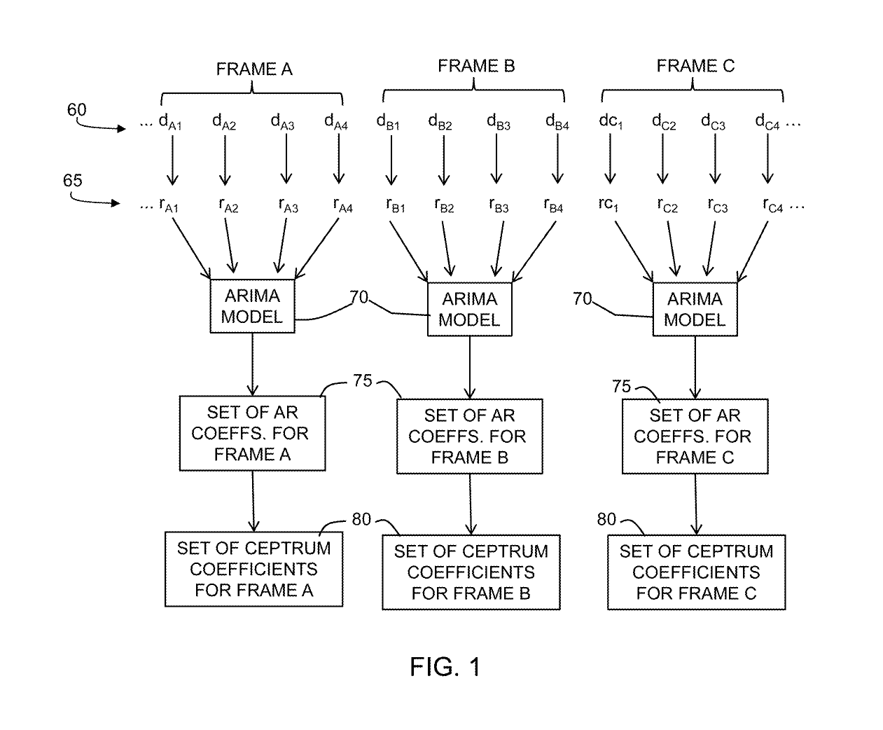

FIG. 1 illustrates time series data 60. The data 60 is represented by a time-series of data points designated as “d.” In some examples and as noted above, the data may be flow rate sensor data from, for example, a well. The data may be divided into “frames” A, B, C, etc. The data of each frame is classified into one of the various regimes—that is, classification is performed on a frame-by-frame basis. The data frames may or may not be overlapping. The example of FIG. 1 shows non-overlapping data frames (i.e., the frames do not share any data points), but in other implementations, the frames may overlap (i.e., adjacent frames may share one or more data points). The data of frame A is designed as d_{A1}, d_{A2}, d_{A3}, and dₘ designating the data as data points 1-4 of frame A. Similarly, the data of frame B is designated as d_{B1}, d_{B2}, d_{B3}, and d_{B4} while the data of frame C is designated as d_{C1}, d_{C2}, d_{C3}, and d_{C4}.

Some autoregressive models do not perform well if the underlying time-series data includes a linear trend. A linear trend is a slow variation of the mean of the data across multiple frames. Thus, any linear trend in the time series may be removed. Any suitable technique for removing a linear trend from the time-series data may be used. For example, the linear trend may be removed by computing the residual error of a linear regression model imposed on the time series data. The residual for each data point in the time-series data is computed as:

rᵢⱼ=dᵢⱼ−(α+j*β)

where rᵢⱼ is the residual error (or simply “residual”) of the jth data point for regime i within a frame, dᵢⱼ is the jth data point d for regime i within a frame, and α and β are the intercept and slope coefficients of the linear regression model imposed on the time-series data of the frame. The resultant residual is assumed to follow a p^{th} order autoregressive model. The linear trend may be removed from each data point by subtracting from the data point the quantity (α+j*β), The quantity (α+j*β) is an estimated regression function capturing trend. The residuals are shown in FIG. 1 as residuals 65.

An ARIMA model 70 is then fit to the set of residuals for each frame. The autoregressive model may be represented by:

$${r}_{ij} = {\sum }_{k - 1}^{p} {φ}_{ik} {r}_{( j - k )} + {ε}_{j}$$

where φᵢₖ are the AR coefficients of the model and εⱼ represents the error in the model. The resulting AR coefficients are denoted as 75 in FIG. 1. The AR coefficients may be estimated using, for example, the Yule-Walker equations or the Levinson-Durbin iterative procedure. The autoregressive or moving average coefficients from the ARIMA model are obtained by solving the Yule-Walker equations using a system of difference equations derived from the autocorrelation structure, or alternately by the Levinson-Durbin algorithm.

The AR coefficients further may be converted into cepstrum coefficients as indicated by 75 in FIG. 1. The conversion of AR coefficients into cepstrum coefficients may include computing the inverse Fourier transform of the log of the inner product between the observations and the Fourier basis functions (sinusoids and cosinusoids).

The process of removing any linear trend in the time-series data to compute residuals, fitting an ARIMA model to the residuals to generate AR coefficients, and converting the AR coefficients to cepstrum coefficients is the same for processing training data and for processing live (i.e., non-training) data. For training data (e.g., HAO training data, NO training data, LAO training data), the cepstrum coefficients represent a “feature” extracted from the training data that is then used to classify live data. For live data, once the cepstrum coefficients are computed, the cepstrum coefficients from the training data and the cepstrum coefficients from the live data are used in the classification process of the live data.

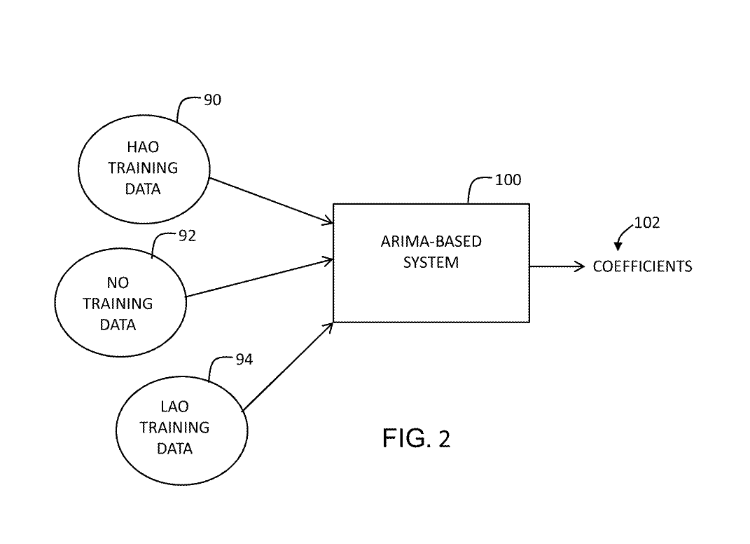

FIG. 2 illustrates an ARIMA-based system 100 that receives training data 90, 92, and 94. Training data 90 includes data which is known apriori to be characteristic of HAO data, and is referred to as HAO training data. Training data 92 is characteristic of NO data (NO training data) and training data 94 is characteristic of LAO data (LAO training data). In at least some implementations, the ARIMA-based system 100 receives each set of training data 90-94, one at a time, and processes the training data to produce coefficients 102 (e.g., cepstrum coefficients) indicative of that training data. The coefficients 102 are unique to each regime and thus can be used to classify live data into one of the regimes.

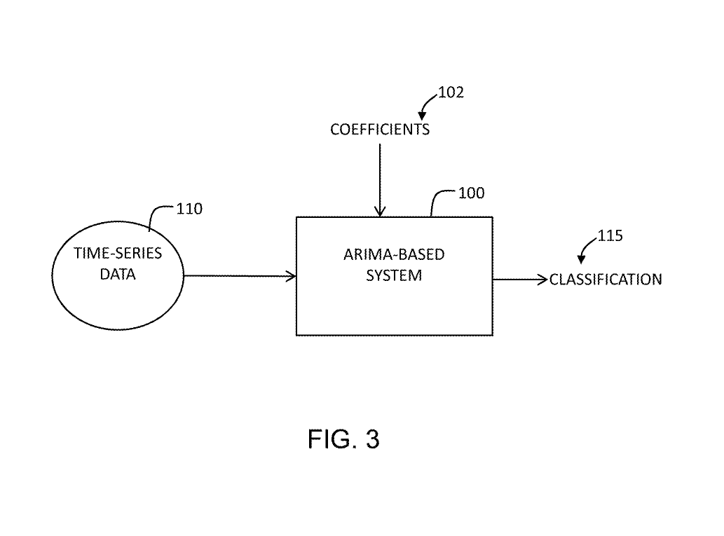

FIG. 3 illustrates the use of the ARIMA-based system 100 to classify live time-series data 110. The live time-series data 110 is provided to the ARIMA-based system 100 which uses the coefficients 102 previously determined for training data of the various regimes to classify the input live time-series data 110. The classification is shown at 115 and indicates to which of the various regimes (e.g., HAO, NO, LAO) the live time-series data 110 belongs.

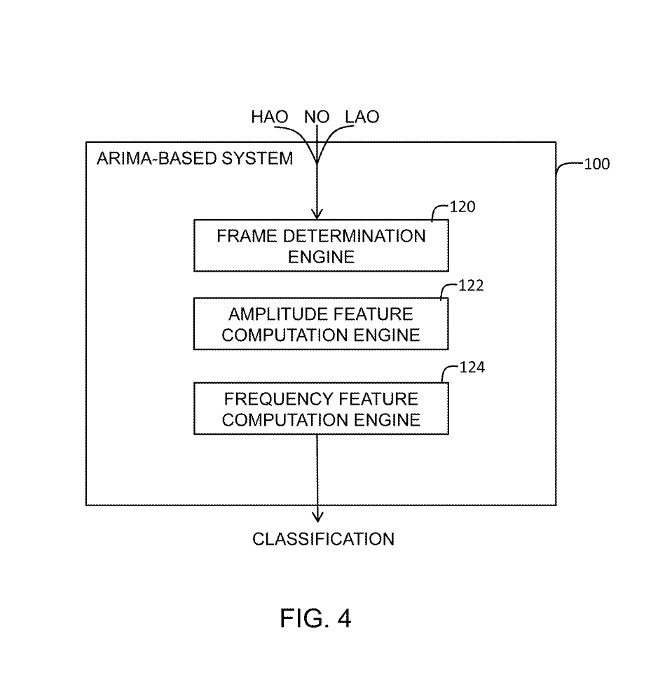

FIG. 4 illustrates an implementation of the ARIMA-based system 100. The illustrative implementation of system 100 includes an AR model fit engine 120, a cepstrum coefficient engine 122, and a classification engine 124. The various engines perform the functionality described herein.

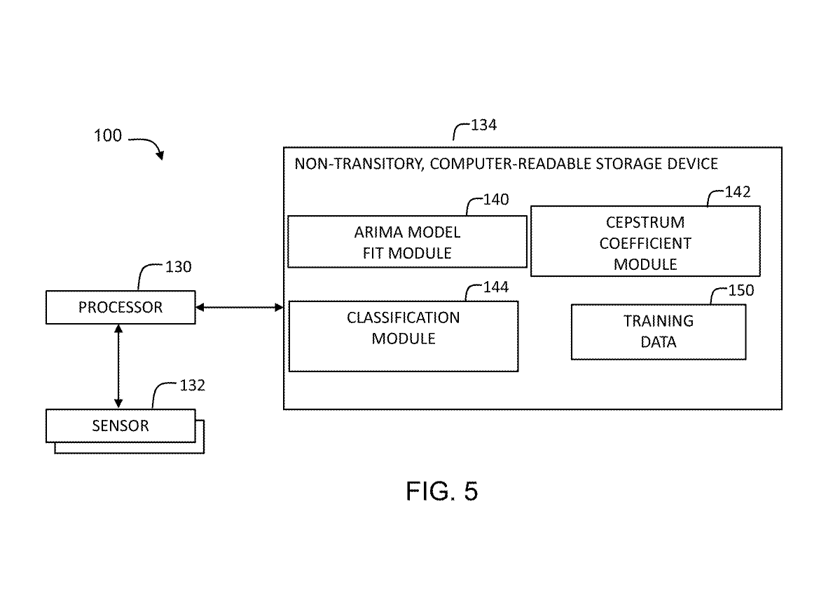

FIG. 5 illustrates another implementation of the ARIMA-based system 100 as including a processor 130 coupled to one or more sensors 132 and a non-transitory, computer-readable storage device 134. The sensors 132 may be flow rate sensors or other types of sensors. The non-transitory, computer-readable storage device 134 may include volatile storage (e.g., random access memory), non-volatile storage (e.g., hard disk drive, Flash storage, optical disc, etc.) or combinations of both volatile and non-volatile storage. The non-transitory, computer-readable storage device 134 includes an ARIMA model fit module 140, a cepstrum module 142, a classification module 144, and training data 150. Each of the modules 140-144 may comprise software executed by the processor 130 to perform any or all of the operations described herein. The various engines 120-124 may be implemented as processor 130 executing the corresponding module 140-144. For example, the AR model fit engine 120 may be implemented as the processor 130 executing the ARIMA model fit module 140.

Any references herein to the operation performed by a particular engine should be understood, in at least some implementations, to be performed by the processor 130 executing the corresponding module.

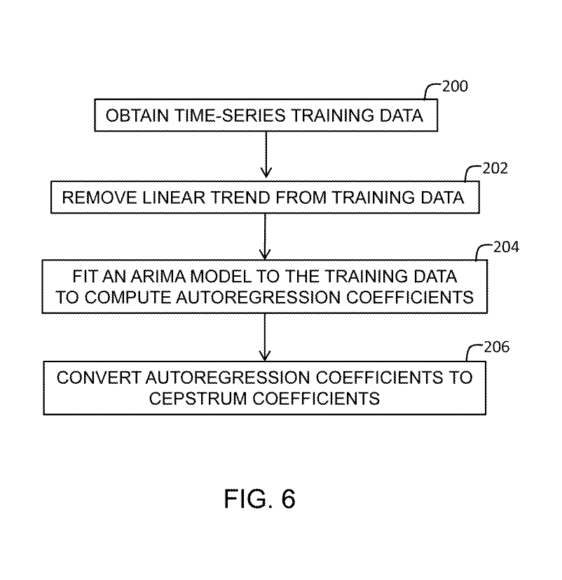

FIG. 6 illustrates a method for processing training data to generate cepstrum coefficients for the training data set. The method of FIG. 6 may be repeated for each training data set of the various classification regimes of interest. The various operations shown in FIG. 6 may be performed by some or all of the engines of FIG. 4 and/or processor 130 executing the various modules of FIG. 5. At 200, the method includes obtaining time-series training data (e.g., retrieving training data 150 from non-transitory, computer-readable storage device 134). The retrieved training data is determined apriori to be characteristic of a particular regime (e.g., HAO regime, LAO regime, NO regime).

At 202, the method comprises removing any linear trend from the training data. This operation may be performed by the ARIMA model fit engine 120. An example of a technique for removing linear trend is described above. The results of the removal of the linear trend may be the residuals as described previously.

At 204, the method further includes fitting an ARIMA model to the training data (e.g., to the training data 150 itself or to the residuals computed from the training data). This operation may be performed by the AR model engine 120. As a result of fitting an ARIMA model to the training data, AR coefficients are computed. At 206, the AR coefficients then are converted to cepstrum coefficients by, for example, the cepstrum coefficient engine 122. An example of a technique for converting autoregression coefficients to cepstrum coefficients is described above. The resulting cepstrum coefficients are unique to the regime on which the training data is based. The method of FIG. 6 is repeated for training data of all other regimes of interest thereby resulting in a set of cepstrum coefficients unique to each such regime. The cepstrum coefficients may be used to classify live data into one of the various regimes.

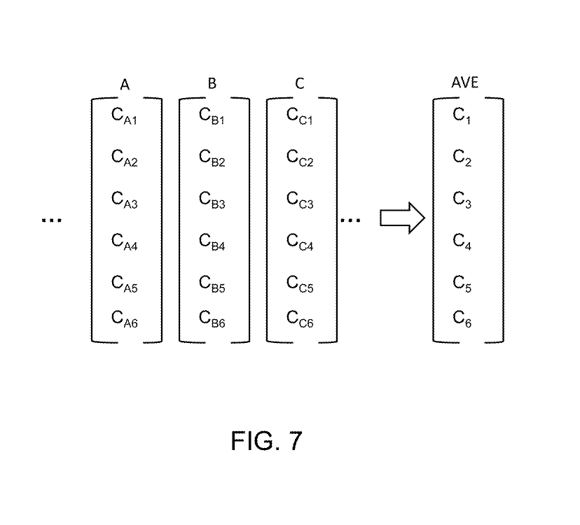

The method of FIG. 6 is performed on each frame of the training data. Thus, the AR coefficients and the corresponding cepstrum coefficients are computed on a frame-by-frame basis. In some implementations, the cepstrum coefficients across the various frames are combined together. FIG. 7, for example, illustrates a set of cepstrum coefficients for each of various frames A, B, and C. The cepstrum coefficients for frame A are listed as C_{A1}-Cₘ, while the cepstrum coefficients for frames B and C are listed as C_{B1}-C_{B6} and C_{C1}-C_{C6}, respectively. The cepstrum coefficient engine 124 may combine the corresponding cepstrum coefficients across the various frames. For example C_{A1}, C_{B1}, and C_{C1} may be combined together to generate cepstrum coefficient C₁. Similarly, C_{A2}, C_{B2}, and C_{C2} may be combined together to generate cepstrum coefficient C₂, and so on to generate cepstrum coefficients C₁-C₆. In some implementations, the combination of cepstrum coefficients across frames includes computing an average of the coefficients, but mathematical combinations other than averaging is possible in other implementations.

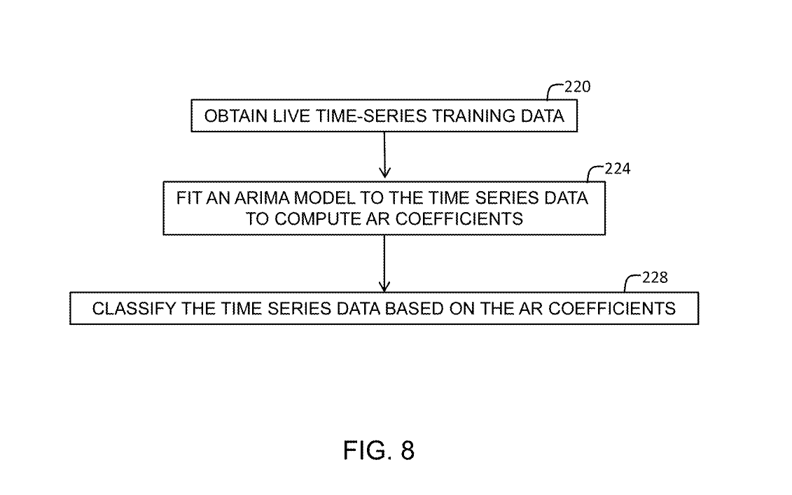

FIG. 8 illustrates a method for classifying live time-series data. The method of FIG. 8 may be performed by some or all of the engines of FIG. 4 and/or processor 130 executing the various modules of FIG. 5.

At 220, the method includes obtaining live time-series data. Such live time-series data may be collected from one or more sensors 132 (e.g., flow rate sensors). The live time-series data may also be divided into frames and any linear trend may be removed.

At 224, the method further includes fitting an ARIMA model to the live time-series data of each frame. This operation may be performed by the AR model fit engine 120. As a result of fitting an ARIMA model to the live time-series data, AR coefficients are computed, as explained previously. At 228, the live time-series data is classified based on the AR coefficients as further explained below (e.g., based on cepstrum coefficients derived from the AR coefficients). The classification of the live time-series data may be performed on a frame-by-frame basis, thereby classifying each frame of data into one of the various regimes.

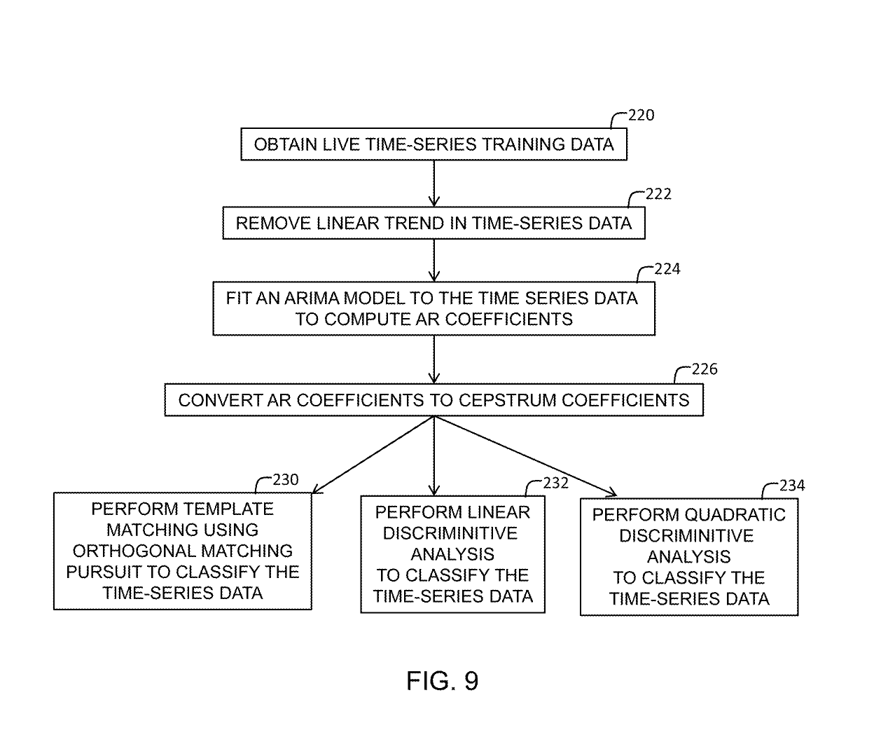

FIG. 9 also illustrates an example of a method for classifying live time-series data. The method of FIG. 9 may be performed by some or all of the engines of FIG. 4 and/or processor 130 executing the various modules of FIG. 5.

At 220 and as noted above, the method includes obtaining live time-series data. Such live time-series data may be collected from one or more sensors 132 (e.g., flow rate sensors) and divided into frames.

At 222, the method includes removing any linear trend from the training data. This operation may be performed by the AR model fit engine 120. An example of a technique for removing linear trend is described above. The results of the removal of the linear trend may be the residuals as described previously.

At 224, the method further includes fitting an ARIMA model to the live time-series data of each frame. This operation may be performed by the AR model fit engine 120. As a result of fitting an ARIMA model to the live data, AR coefficients are computed, as explained previously.

At 226, the method further includes converting the AR coefficients to cepstrum coefficients using a suitable technique such as that described above.

In the method of FIG. 8, the live time-series data is classified based on the AR coefficients (operation 228). The classification of the live time-series data may be performed on a frame-by-frame basis, thereby classifying each frame of data into one of the various regimes. FIG. 9 illustrates examples of three techniques for classifying the live time-series data based on the AR coefficients. The three example techniques include template matching using orthogonal matching pursuit (230), linear discriminative analysis (LDA) (232), and quadratic discriminative analysis (QDA) (234). These three classification techniques are described below.

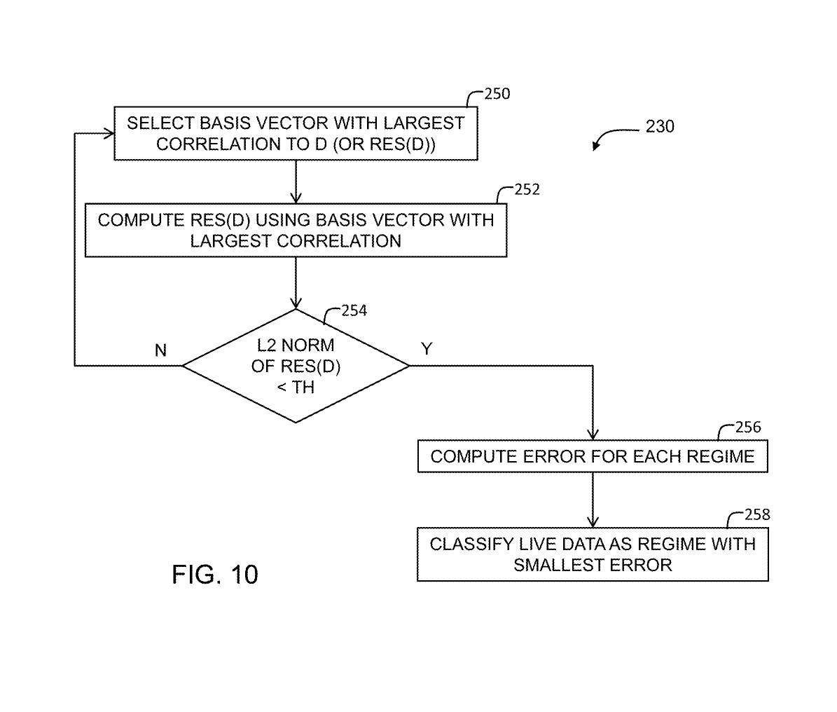

FIG. 10 illustrates an example of the template matching using orthogonal matching pursuit technique 230. At 250, the method includes selecting a basis vector that has the largest correlation to the data d turned into cepstrum coefficients as previously explained (or residual of data d). This operation may include concatenating vectors of cepstrum coefficients derived from the training data for the various regimes. Then, the correlation is computed of the first column of cepstrum coefficients from the matrix formed from the concatenated vectors with regard to the cepstrum coefficients computed from the live time-series data. This correlation operation is repeated for all other columns of cepstrum coefficients from the matrix formed from the concatenated vectors, and the column of cepstrum coefficients that has the largest correlation is selected as the basis vector.

At 252, the method includes computing the residual of the live time-series data using the basis vector selected from 250. The residual may be calculated using the following equation:

res(d)=d−A\hat{X}

where d is the data value, A is the concatenated vectors of cepstrum coefficients noted above, and X is the data d turned into a vector of cepstra from the live time-series data.

Operations 250 and 252 are repeated until the L2 norm of the residual falls below a specified threshold (254). The L2 norm is the Euclidean distance.

At 256, the method includes computing the error for each regime. This operation may be performed by computing:

eₘ=∥d−Aₘ\hat{X}ₘ∥²₂

where the subscript m refers to the regime. The live time-series data is classified into the regime which returns the smallest error value, eₘ.

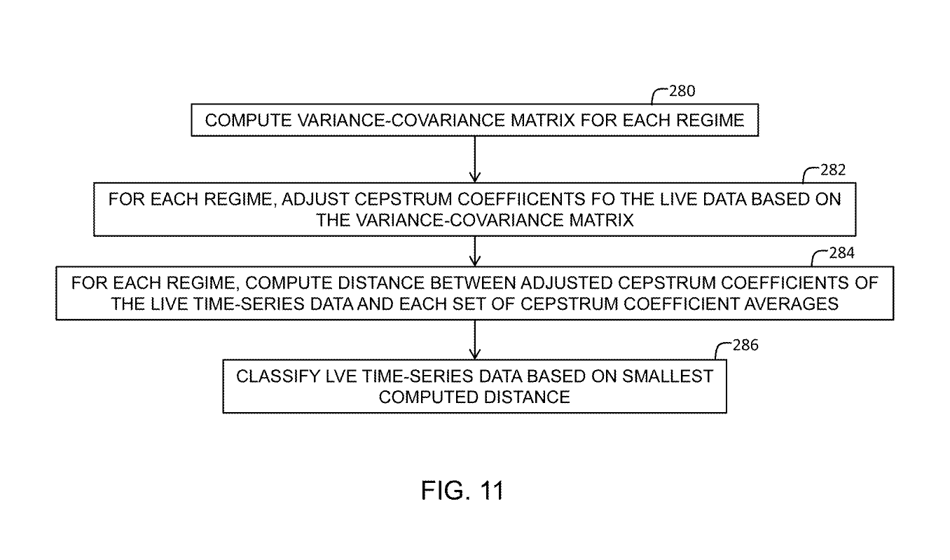

FIG. 11 shows an example of a discriminative analysis technique that is applicable to both the LDA technique 232 and the QDA technique 234. At 280, the technique includes computing a variance-covariance matrix for each regime based on that regime's cepstrum coefficients. The LDA assumes that the three regimes (HAO, LAO, and NO) are equi-covariant and therefore the covariance matrices are pooled. The covariance matrix is merely the variances and pair-wise covariance between the cepstrum coefficients. The QDA assumes that the covariance across the three regimes is different and treated accordingly in the decision function used to determine class membership of a live vector to a regime.

For each regime, at 282 the method further includes adjusting the cepstrum coefficients computed from the live time-series data based on the variance-covariance matrix. 282.

As explained previously, the cepstrum coefficients computed for each frame of training data may be averaged together. The set of cepstrum coefficient averages is used in operation 284. For each regime, the method further includes computing a distance between the adjusted cepstrum coefficients of the live time-series data and each set of cepstrum coefficient averages. At 286, the live time-series data is classified based on the smallest computed distance. That is, the regime having a set of average cepstrum coefficients that is closed to the adjusted cepstrum coefficients for the live time-series data is determined to be the matching regime for the live time-series data.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
collecting time-series data;
fitting, by an autoregression model fit engine, an autoregressive integrated moving average (ARIMA) model to the time-series data to compute autoregression coefficients; and
classifying, by a classification engine, the time-series data based on the autoregression coefficients.

2. The method of claim 1 wherein classifying the time-series data comprises performing discriminative analysis.

3. The method of claim 1 wherein classifying the time-series data comprises performing linear or quadratic discriminative analysis.

4. The method of claim 1 wherein classifying the time-series data comprises performing template matching using orthogonal matching pursuit.

5. The method of claim 1 further comprising computing cepstrum coefficients from the autoregression coefficients.

6. The method of claim 5 wherein classifying the time-series data comprises:
selecting a basis vector that has a largest correlation to the cepstrum coefficients;
computing the residual of the time-series data using the selected basis vector; and
computing the L2 norm of the residual.

7. The method of claim 1 further comprising, for each of a plurality of training data sets, each training data set corresponding to one of a plurality of classifications, fitting an ARIMA model to the training data set to compute autoregression coefficients, and wherein classifying the time-series data comprises using both the autoregression coefficients and the autoregression training coefficients.

8. The method of claim 1 further comprising converting the autoregression coefficients to cepstrum coefficients and wherein classifying the time-series data uses the cepstrum coefficients.

9. The method of claim 1 further comprising removing a linear trend from the time-series data.

10. A non-transitory, computer-readable storage device containing software that, when executed by a processor, causes the processor to:
fit an autoregressive model to time-series data to compute autoregression coefficients;
convert the autoregression coefficients to cepstrum coefficients; and
classify the time-series data based on the cepstrum coefficients.

11. The non-transitory, computer-readable storage device of claim 10 wherein the software causes the processor to classify the time-series data by performing at least on one of linear discriminative analysis, quadratic discriminative analysis, and template matching using orthogonal matching pursuit.

12. The non-transitory, computer-readable storage device of claim 10 wherein the software causes the processor to fit to the time series-data an autoregression model that is based on either Yule-Walker equations or a Levinson-Durbin iterative procedure.

13. The non-transitory, computer-readable storage device of claim 10 wherein the software causes the processor to compute autoregression coefficients for each of a plurality of training data sets, each training data corresponding to one of a plurality of classifications.

14. The non-transitory, computer-readable storage device of claim 11 wherein the software causes the processor to classify the time-series data based on the cepstrum coefficients and the autoregression coefficients for each of the plurality of classifications.

15. The non-transitory, computer-readable storage device of claim 11 wherein the software causes the processor to convert the autoregression coefficients for each of the plurality of classifications into cepstrum coefficients for each of the plurality of classifications and to classify the time-series data based on both the cepstrum coefficients from the time-series data and from each of the plurality of classifications.

16. The non-transitory, computer-readable storage device of claim 11 wherein the software causes the processor to classify the time-series data by:
selecting a basis vector that has a largest correlation to the cepstrum coefficients;
computing the residual of the time-series data using the selected basis vector;
computing the L2 norm of the residual;
computing an error for each of a plurality of regimes until the L2 norm is less than a threshold; and
selecting a regime for classification resulting in the smallest error.

17. A system, comprising:
an autoregressive integrated moving average (ARIMA) model fit engine to receive time-series training data for each of a plurality of regimes and to fit an ARIMA model to the time-series training data to thereby generate autoregression coefficients; and
a cepstrum coefficient engine to generate cepstrum coefficients based on the autoregression coefficients, the cepstrum coefficients usable to classify live time-series data into one of the regimes.

18. The system of claim 17 wherein the ARIMA model fit engine is to remove a linear trend from the time-series training data to produce residuals.

19. The system of claim 17 wherein the cepstrum coefficient engine is to generate the cepstrum coefficients for each of a plurality of frames of time-series training data of each regime and to average a subset of the cepstrum coefficients across the frames.

20. The system of claim 17 further comprising a classification engine to classify live time-series data based on the cepstrum coefficients.
